(19) United States
(12) Patent Application Publication
(10) Pub. No.: US 2011/0145174 A1
(43) Pub. Date: Jun. 16, 2011

(54) Hair Color Based Method of Choosing Hair Accessories

(75) Inventors: Lisa C. King, Atlanta, GA (US); Deborah Rubin, Atlanta, GA (US)

(73) Assignee: Goody Products, Inc., Atlanta, GA (US)

(21) Appl. No.: 13/030,620

(22) Filed: Feb. 18, 2011

Related U.S. Application Data
(62) Division of application No. 11/402,175, filed on Apr. 11, 2006.

(51) Int. Cl. G06Q 90/00

(52) U.S. Cl. 705/500

(57) ABSTRACT

A method of choosing hair accessories based on a hair color of a user. The method includes browsing a display device containing a first set of hair accessories and a second set of hair accessories. Each hair accessory of the first and second sets is of a different accessory type and has a first or second color, respectively. The method also includes inputting the hair color of the user to a hair accessory selection device populated with information relating to the first and second colors and to a range of hair colors. The method further includes receiving from the hair accessory selection device one or more recommended hair accessories from the first and second sets that best match the hair color of the user. The method also includes selecting one or more accessories from the display device based upon the one or more recommended hair accessories.

This application is a divisional of application Ser. No. 11/402,175, filed Apr. 11, 2006, which is hereby incorporated by reference herein in its entirety.

The present disclosure relates generally to hair accessories and, more particularly, to a method and device for choosing and providing hair accessories based on hair color.

### BACKGROUND OF THE DISCLOSURE

Hair accessories such as hair bands, hair clips, barrettes, ponytail holders, claw clips, and bobby pins have been utilized for many years in shaping and holding a user's hair. These and other hair accessories are available in various colors. For example, hair bands generally come in common colors such as black, gray, white, etc. or include patterns and motifs depending on the fabric used and the desired style of the product. Similarly, ponytail holders and barrettes are available in various colors and styles, which may depend on the anticipated appeal to the target customer, material used, and other factors related to the manufacturing and marketing of the products.

Given the variety of products and colors, users may purchase hair accessories based on the type of hair accessory they wish to utilize, or may purchase hair accessories based on the color they wish the hair accessory to have. However, not all hair accessories are available in all colors, leaving the consumer to settle for purchasing products that may not be the optimal color, or type of hair accessory they would prefer to purchase. This is especially evident when a user attempts to purchase a particular type of hair accessory to match the user's hair color.

For example, a user with blonde hair wishing to purchase a claw clip that matches the user's hair may find claw clips that are black or brown in color or may have a multicolor design, but not a claw clip that is blonde in color. In contrast, the user may find a barrette of a blonde color, but the barrette may not be suited for the purpose intended by the user. Accordingly, there is a need to provide a variety of hair accessories that all have the same color and, in particular, that have colors that are matched to the colors generally worn by users or matched to the user's hair colors such that the accessories blend in with the user's hair when the accessories are worn.

### BRIEF DESCRIPTION OF THE DRAWINGS

FIG. 1 is a front view of a display configuration for sets of hair accessories in a display area;

FIG. 2 is a front view of an alternative display configuration for sets of hair accessories in a display area;

FIG. 3 is a front view of hair accessories on a display package having a colored backing;

FIG. 4 is a front view of hair accessories on a display package having a colored backing, similar to FIG. 3;

FIG. 5 is a front view of hair accessories on a display package having a colored backing, similar to FIG. 3;

FIG. 6 is an isometric view of a hair accessories display area including a hair accessories selection device and a reflective surface;

FIG. 7 is an isometric view of a dyeable hair accessory;

FIG. 8 is an isometric view of a claw clip with colorable inserts; and

FIG. 9 is an isometric view of a claw clip with a colorable cover.

While the method and device described herein are susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the disclosure and the claims.

### DETAILED DESCRIPTION

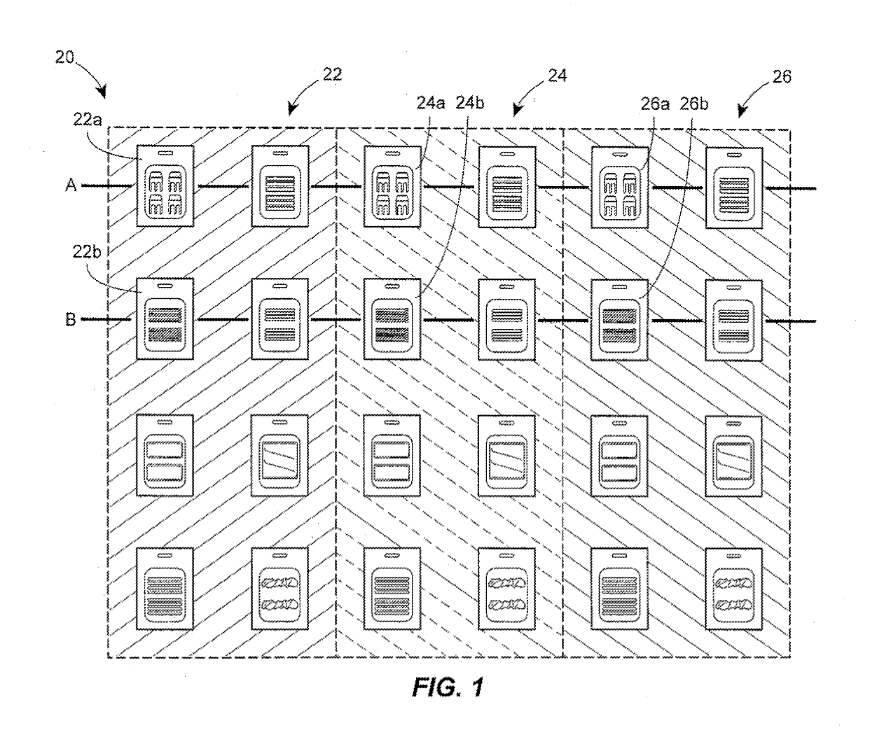

Referring now to the drawings, and with specific reference to FIG. 1, a hair accessories system in accordance with the teachings of the disclosure is generally depicted by reference numeral 20. As shown therein, the system 20 includes a first set of hair accessories 22, a second set of hair accessories 24, and a third set of hair accessories 26. The system 20 may include additional sets of hair accessories, such as a fourth set, a fifth set, etc. However, for the sake of brevity, the system 20 is described herein with reference to illustrated sets 22, 24 and 26.

The sets 22, 24 and 26 each include various types of hair accessories. For example, the first set 22 may include, but is not limited to, hair bands, head bands, head scarves, hair rollers, hair curlers, hair combs, hair clips, barrettes, bobby slides, ponytail holders/elastic bands, contour clips, fabric covered elastic bands, claw clips, and bobby pins. The term “elastics” or “elastic bands” may include, but is not limited to, braided elastics, fabric covered elastics, charmed elastics, latex elastics, twin-bead elastics, ribbon elastics, terry-o elastics, and woven cut band elastics. Furthermore, within each of the various types of hair accessories there may various sub-types. For example, a claw clip—one type of hair accessory—may include, mini-claw clips, heavy-duty claw clips, etc. The sets 24 and 26 may include similar arrays of hair accessories.

The sets 22, 24 and 26 are each defined by different colors such that all of the various types of hair accessories in each set have the same color. In particular, the colors of each of the sets may be matched or particularly chosen to match a hair color or common hair colors generally worn by users. For example, the colors may be chosen to match or closely match blonde, brown, light brown, red, auburn, black, etc. In addition, the colors may be chosen to match or closely match one or more of the above mentioned hair colors with additional color features or hair treatments such as, for example, highlights, lowlights, chunky highlight, shine glaze, etc. For example, a secondary color may be added to the hair accessory in the form of streaks or lines to represent highlights or lowlights. The hair accessories, however, may be modified and altered in a variety of ways in order to achieve the appropriate color and the look of having the additional color feature or hair treatment, which may be completed during a primary or secondary process. For example, the hair accessories may be painted with stripes, streaks or other pattern, coated, pearlized, marbleized, overmolded, inlayed, include glitter, etc.

In another exemplary embodiment, the colors of the sets may be matched to existing hair dye colors that are commercially available. As such, a user could color her hair a certain color, and then purchase hair accessories of that same color such that the accessories blend in with the user's hair. For example, commercially available hair coloring kits are provided by among others, Loreal.™., Clairol.™., and Garnier.™., and include a large array of colors such as medium ash blonde, light gold brown, etc. In this way, a full range of accessories may be provided for each hair color to which a set of accessories is matched.

The colors to which the sets of hair accessories 22, 24 and 26 are matched may be chosen in a variety of ways. In one exemplary embodiment, the various hair colors worn by user may be placed into several categories. For example, the categories may include blonde, brown, black, red, grey, etc. These categories may then be further broken down into shades of colors. For example, blonde may include beach and butterscotch, brown may include truffle and cocoa, red may include cooper and cinnamon, black may include sable and onyx, etc. Once the categories and the shades are established, the colors to be used may be determined by which category, shade or shades within the category is most commonly worn by consumers. Alternatively, the colors may be chosen by which color is most popular, easy to color match, cost effectively to manufacture, etc.

Now referring again to FIG. 1, the sets of hair accessories 22, 24 and 26 may be displayed in a display area that is provided along with the sets of hair accessories 22, 24 and 26, but in most instances will be displayed in existing display space installed at the sellers location. In either display, the sets of hair accessories 22, 24, 26 may be displayed together as a collection, such that the sets of hair accessories 22, 24, 26 stand out from other hair accessories offered by the same or other manufacturers that are not part of the collection. In doing so, the sets of hair accessories 22, 24, 26 may be displayed in sections such that each section corresponds to or is defined by the color of the corresponding set. In addition, as illustrated in FIG. 1, each of the sections may be defined with a color that corresponds to the set disposed in that section. For example, a background of the section that corresponds to a set of brown hair accessories may be colored brown. In doing so, it is easily discernible where the various sets of accessories are on the display area.

The sections may then be arranged relative to each other to provide various merchandizing goals. For example, as illustrated in FIG. 1, the sections may be configured in a vertical orientation, such that the sections are more elongate in the vertical direction than in the horizontal direction. In this arrangement, the sections are oriented side-by-side. When in this vertical orientation, the same types of hair accessories within the sections may be aligned or arranged along the same horizontal axis. For example, the first set of hair accessories may include claw clips 22a, bobby pins 22b, etc. in the color of the first set 22 and the second set of hair accessories may include claw clips 24a, bobby pins 24b, etc. in the color of the second set 24. Therefore, when the sections are arranged side-by-side, the claw clips 22a, 24a may be arranged along a first horizontal axis A and the bobby pins 22b, 24b may be arranged along a second horizontal axis B, such that each accessory is disposed in a consistent location within the section of each set 22, 24, 26.

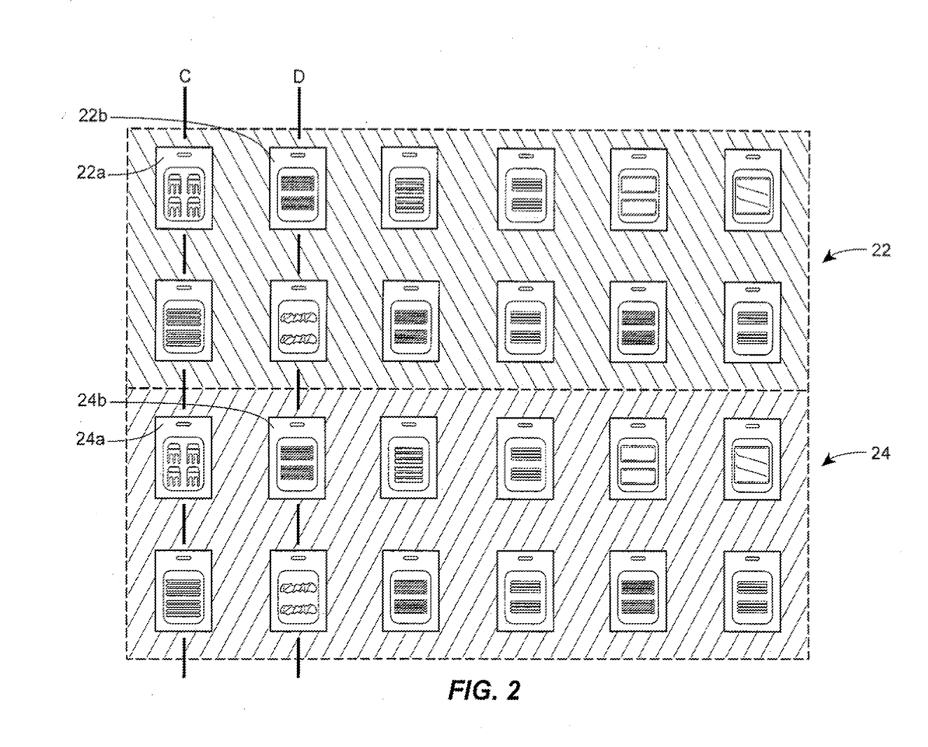

Alternatively, as illustrated in FIG. 2, the sections may be configured in a horizontal orientation, such that the sections are more elongate in the horizontal direction than in the vertical direction. In this arrangement, the sections are oriented one over the other. When in this horizontal orientation, similar hair accessories within the sections may be aligned or arranged along a vertical axis, such that each accessory is disposed in a consistent location within the display of each set 22, 24. For example, the claw clips 22a, 24a may be arranged along a first vertical axis C and the bobby pins 22b, 24b may be arranged along a second vertical axis D.

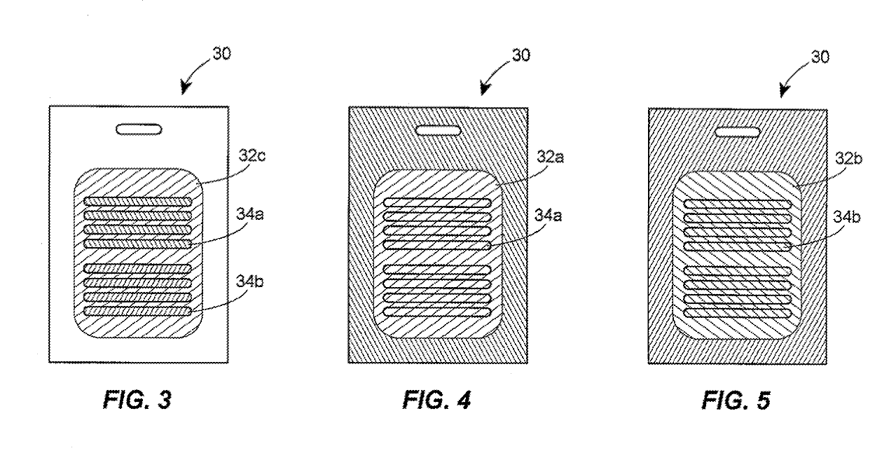

Referring now to FIGS. 3, 4 and 5, the hair accessories may be provided with packaging such as a backing or backboard 30 that may be provided in any variety of shapes and sizes, and may include additional packaging components, such as a plastic casing, shrink wrap, blister packaging, a box, or other container, a reinforcement ring and the like (all not shown). Each of the hair accessories preferably includes some shape or form of backing 30 to which the hair accessory is attached or within which the hair accessory is encased. In the illustrated example, the backing 30 may be colored or may include a colored area 32 having a color corresponding to the color of the hair accessory to which it is attached or corresponding to the set 22, 24, 26 of which the hair accessory is a part. As such, each of the respective sections not only have the same color hair accessories, but also have the same color backing. Thus, the colored area 32 may be used to identify a set of hair accessories or, as explained in more detail below, may also be used to identify a shade and/or a color category. In one exemplary embodiment, all of the hair accessories of the same color category may have the same color backing, but in an alternate embodiment, the color of the backing may change depending on the shade within that category and/or the feature within that category. For example, the blonde hair accessories may be elastic bands 34 that come in two different shades of blonde—beach (a) and butterscotch (b). (The alpha identifiers in FIGS. 3, 4 and 5 are each representative of a different color, whether it be a shade of color, a category of color, etc.) In the first example, the backing 30 includes beach elastic bands 34a and butterscotch elastic bands 34b, and has a blonde colored area 32c, which may be a generic blonde or other blonde color (FIG. 3). In contrast, in the second example the beach colored elastic bands 34a are disposed on a beach colored area 32a (FIG. 4) and the butterscotch elastic bands 34b are disposed on a butterscotch colored area 32b (FIG. 5).

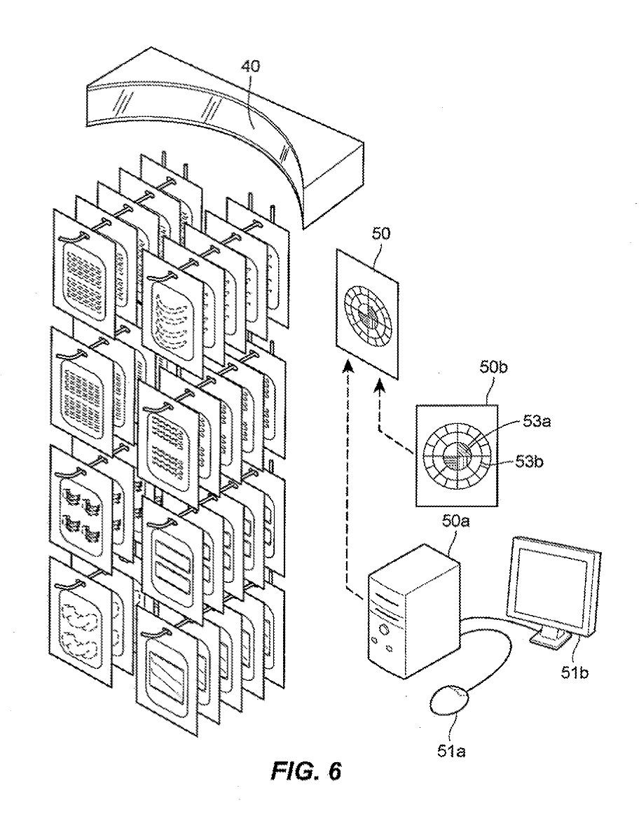

Referring now to FIG. 6, the display (depicting only one set of hair accessories) may include additional components including a reflective surface 40 and a hair accessories selection device 50. The reflective surface 40 may be any type of surface that allows the user to view her hair or hair color, and may be mounted adjacent the display, the sections or the sets of accessories. As illustrated in FIG. 6, the reflective surface may be a minor disposed along the display area. The reflective surface 40 may have a variety of shapes, including a concave shape such that a user can more easily view her hair or hair accessories.

The hair accessories selection device 50 may be used to aid the customer in choosing the proper color and/or type of hair accessory. For example, the hair accessories selection device 50 may be a programmable controller or computer 50a workable via a keyboard, mouse 51a, touchscreen 51b, or the like, a color wheel 50b, a color chart, or other device able to receive an input and able to provide an output. For example, in using the accessories selection device 50a, the customer may begin the hair accessory selection process by identifying the color of the customer's hair. This may be done by comparing the customer's hair to colors displayed on the selection device 50a and then choosing the best color match on the selection device 50a. Alternatively, the customer may be required to make additional choices in selecting the best color match. For example, instead of simply choosing the best color match on the selection device 50a, the customer may go through several steps such as first choosing a hair category, such as blonde, and then choosing a shade within that category, such as beach.

Based on the color selected, the selection device 50a will provide the color of hair accessories that most closely matches the user's hair color. The selection process may further include selection by the customer of the type of look the customer desires. The type of look may be characterized as casual, dramatic, professional, or the like. Based on the information provided, the selection device 50a will select/suggest a list of hair accessories, all of which are of the same color, that are best suited for the customer's hair color and desired look.

The same or similar results may be obtained with the color wheel 50b. The color wheel 50b may include one or more wheels able to spin relative to each other about a single axis. In particular, a first or inner wheel 53a may include a range of hair colors disposed radially about the inner wheel 53a such that the customer can select the hair color that best matches her own hair color. Once the best matched hair color is chosen, the color wheel 50b will determine the color of hair accessory that best matched that hair color. This may all be accomplished on the inner wheel 53a. A second or outer wheel 53b may include various looks disposed radially about the outer wheel 53b such the customer may rotate the wheels 53a, 53b relative to each other, to align the color of hair accessory with the type of look desired. As a result, the color wheel 50b will suggest a list of hair accessories, which may be disposed on the outer wheel 53b, that are best suited for the customer's hair color and desired look.

For example, the customer may chose her hair color—dirty blonde—from a plurality of different hair colors on the inner wheel 53a. Accordingly, the color wheel 50b may identify the butterscotch colored hair accessories as the best color match. The customer may then choose to have a casual look. By aligning the butterscotch color on the inner wheel 53a with a causal look on the outer wheel 53b, the color wheel 50b may suggest using a butterscotch colored elastic band or fabric covered elastic band. In contrast, if the user chose to have a professional look, to color wheel 50b may suggest a butterscotch colored bobby slide or barrette, for example.

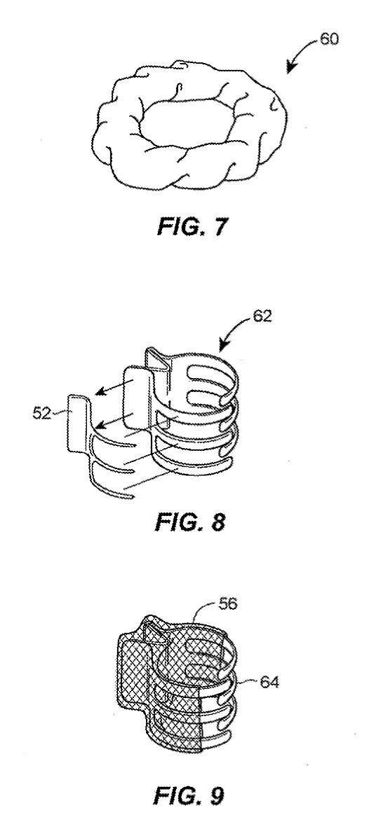

The above embodiments may be varied to achieve and/or create additional or alternative features. For example, the hair accessories may be dyeable, colorable or paintable. For example, as illustrated in FIG. 7, a fabric covered elastic band 60 may be constructed from a dyeable or colorable material. In this example, the user can dye the fabric covered elastic band 60 with the same coloring used to dye her hair, such that the hair and the hair accessory have essentially the same color. In one example, the hair coloring may be provided with the colorable hair accessory such that user can chose the type of hair accessory or accessories she wishes to purchase, and can then choose an adjacently provided color. Alternatively, the user may chose a hair color provided by another manufacturer.

In another embodiment, as illustrated in FIGS. 8 and 9, the hair accessories may themselves not be colorable, but are able to receive colorable inserts 52 (FIG. 8) or be covered by a colored or colorable covering 56 (FIG. 9). In particular, a claw clip 62, which once again is representatives of the other hair accessories, may include one or more inserts 52 disposed on various portions of the claw clip 62 such that the color of the claw clip 62 may be altered with the inserts 52 to match the user's hair color. The inserts 52 may be provided in various colors corresponding to the sets of colors, such that the user would simply purchase or place the desired color insert 52 into the hair accessory. Alternatively, the insert 52 may be colored or colorable using any of the above mentioned techniques and methods.

Referring now to FIG. 9, a representative claw clip 64 is illustrated with a cover 56. The cover 56 may be provided in various colors corresponding to the sets of colors, such that the user would simply purchase or place the desired color cover 56 over the hair accessory 64, or the cover 56 may be colored or colorable using any of the above mentioned techniques and methods.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A method of choosing hair accessories based on a hair color of a user, the method comprising the steps of:
browsing a display device containing a first set of hair accessories and a second set of hair accessories, each hair accessory of the first set being of a different accessory type and having a first color and each hair accessory of the second set being of a different accessory type and having a second color different from the first color;
inputting the hair color of the user to a hair accessory selection device, the hair accessory selection device populated with information relating to the first and second colors and to a range of hair colors;
receiving from the hair accessory selection device one or more recommended hair accessories from the first and second sets of hair accessories that best match the hair color of the user; and
selecting one or more hair accessories from the display device based upon the one or more recommended hair accessories.

2. The method of claim 1, wherein the step of inputting further comprises inputting a particular shade of the hair color of the user.

3. The method of claim 1, wherein the step of inputting further comprises inputting a particular look desired by the user.

4. The method of claim 1, further comprising the step of determining the hair color of the user via a reflective surface mounted on the display device.

5. The method of claim 1, wherein the step of inputting further comprises a use of a keyboard, a mouse, and/or a touch screen monitor.

6. The method of claim 1, wherein the step of inputting further comprises rotating a color wheel.

7. The method of claim 6, wherein the step of inputting further comprises rotating an inner wheel configured to spin relative to the color wheel about a single axis, the inner wheel having the range of hair colors disposed radially about the inner wheel.

8. The method of claim 7, wherein the step of inputting further comprises rotating the inner wheel of the color wheel to select the hair color of the user from the range of hair colors.

9. The method of claim 7, wherein the step of inputting further comprises rotating an outer wheel that surrounds the inner wheel and is configured to spin relative to the color wheel or the inner wheel about the single axis, the outer wheel having a variety of looks disposed radially about the outer wheel.

10. The method of claim 9, wherein the step of inputting further comprises rotating the outer wheel of the color wheel to select a particular look desired by the user from the variety of looks.

11. A method for displaying hair accessories for sale, the method comprising:
displaying a first set of hair accessories and a second set of hair accessories via a display device, each hair accessory of the first set being of a different accessory type and having a first color and each hair accessory of the second set being of a different accessory type and having a second color different from the first color;
populating a selection device with a plurality of hair colors, each hair color of the plurality associated with one of the colors of the first and second sets of hair accessories to link each hair color with one of the first and second sets of accessories;
positioning the selection device near the display device; and
configuring the selection device to receive information from a user about a hair color of the user, compare the hair color of the user with the plurality of hair colors, and suggest to the user a suitable color identified from the first and second colors of the first and second sets of hair accessories that best matches the hair color of the user.

12. The method of claim 11, wherein the step of populating further comprises populating the selection device with a plurality of looks, each look of the plurality of looks associated with one or more accessory types within the first and second sets to link each look with one or more hair accessories of the first and second sets.

13. The method of claim 11, wherein the step of configuring further comprises configuring the selection device to receive information from the user about a desired look preferred by the user, compare the desired look with the plurality of looks, and suggest to the user one or more hair accessories from the display device that best matches the hair color of the user and the look desired by the user.

14. The method of claim 11, wherein the step of displaying further comprises displaying the first set of hair accessories in a first display section of the display device and the second set of hair accessories in a second display section of the display device adjacent to and separate from the first section.

15. The method of claim 11, further comprising the step of providing packaging for each hair accessory of the first and second sets of hair accessories, the packaging having a color corresponding to the color of the respective hair accessory.

16. The method of claim 11, further comprising the step of providing each hair accessory of the first set with a first accessory indicia structure and each hair accessory of the second set with a second accessory indicia structure different from the first accessory indicia structure.

17. The method of claim 16, wherein the step of providing further comprises providing the first accessory indicia structure corresponding to the first hair color and the second accessory indicia structure corresponding to the second hair color.

18. The method of claim 11, wherein the step of configuring further comprises configuring a keyboard, a mouse, and/or a touch screen monitor to receive the information from the user.

19. The method of claim 11, wherein the step of populating further comprises populating a color wheel.

20. A method of selecting a hair accessory of an appropriate color and type from a plurality of different accessories, the method comprising the steps of:
actuating a hair accessory selection device populated with information relating to a hair color category, a hair color shade within the hair color category, and a look indicator representative of a type of look for each accessory of the plurality of different accessories;
capturing via the hair accessory selection device the hair color category of a user;
capturing via the hair accessory selection device the hair color shade of the user within the hair color category;
capturing via the hair accessory selection device a desired look preferred by the user within the look indicators;
using the hair accessory selection device to compare the hair color category of the user, the hair color shade of the user, and the desired look with the information for the plurality of different accessories;
suggesting via the hair accessory selection device one or more hair accessories from the plurality of different accessories that best matches the hair color category and hair color shade of the user and the desired look.
